(19) United States
(12) Patent Application Publication
(10) Pub. No.: US 2024/0193294 A1
(43) Pub. Date: Jun. 13, 2024

(54) AUTOMATED PRE-COMMIT SCAN OF APPLICATION CODE FOR PRIVACY PROTECTED DATA ACCESSES

(71) Applicant: Microsoft Technology Licensing, LLC, Redmond, WA (US)

(72) Inventors: Saurav Kumar, Sunnyvale, CA (US); Ming Liao, Menlo Park, CA (US)

(21) Appl. No.: 18/063,068

(22) Filed: Dec. 7, 2022

(51) Int. Cl. G06F 21/62; G06F 8/70

(52) U.S. Cl. CPC G06F 21/6227; G06F 8/70

(57) ABSTRACT

Technologies for protected data management are described. Embodiments include receiving a request to commit a code element to a codebase in a software application. The code element is scanned using a pre-commit scan. The scan includes a query that is customized to identify a protected data element and/or a protected data element access. The scan can identify at least one portion of the code element that accesses the protected data element. A database of registered protected data elements is searched for the protected data element and/or protected data element access. A notification can be generated and sent to a developer account that is associated with the request to commit the code element.

### TECHNICAL FIELD

The present disclosure generally relates to online systems, including managing access to data by applications, processes, or services of online systems.

### BACKGROUND

Online platforms, such as social graph applications or social media platforms, receive vast amounts of data, including data that is associated with specific user profiles or users. In large scale data processing, various portions of such data have many uses, including but not limited to uses as features for training machine learning models and/or recommendation systems.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system 100 that includes a protected data management system 150 in accordance with some embodiments of the present disclosure.

FIG. 2 is a flow diagram of an example method 200 to conduct a pre-commit code scan to identify a code element that accesses privacy sensitive protected data, in accordance with some embodiments of the present disclosure.

FIG. 3 illustrates examples of queries that can be executed by a pre-commit code scan to identify privacy sensitive protected data in a code element before the code element is committed to a codebase, in accordance with some embodiments of the present disclosure.

FIG. 4 is an example of a user interface that includes protected data element access notifications, in accordance with some embodiments of the present disclosure.

FIG. 5 is an example of a user interface that can be used to implement a registration process for registering protected data elements, in accordance with some embodiments of the present disclosure.

FIG. 6 is a flow diagram of an example method 600 of detecting accesses of protected data elements in a code element and managing protected data elements, in accordance with some embodiments of the present disclosure.

FIG. 7 is a block diagram of an example computer system in which embodiments of the present disclosure can operate.

### DETAILED DESCRIPTION

Aspects of the present disclosure are directed to scanning code elements of a codebase for privacy sensitive information and managing an inventory of protected data elements. As used herein, code base or codebase may refer to a collection of computer programming code, e.g., source code, used to build a particular version or implementation of a software system, an application, or a software component. For example, a main repository of application code can be called a codebase.

As the use of online systems continues to grow, the number of protected data elements, i.e., data elements that are subject to existing privacy protections, continues to increase and new privacy protections are continuously emerging and evolving. Examples of data that may be considered protected data elements include personal data relating to users of a social graph application or another type of online system; for instance, age, gender, birthday, and financial data. In some embodiments, information relating to a user's device, such as the device's precise geographic location, camera input, microphone input, or elevated privilege access to the user device, are considered protected data elements. The rules for determining which items of data are protected data elements can be defined by, for example, a device manufacturer, a regulatory organization, a user's personal privacy preferences and settings, or application-specific privacy policies.

Prior approaches require developers to manually disclose protected data elements and do not provide traceability of protected data elements to particular use cases in an automated way. For example, prior approaches do not track uses of protected data elements at a granular level, such as by individual code element. Code element as used herein may refer to a portion of code identified by a pull request but which is not yet in a codebase. A pull request, also referred to as a merge request, is an event that takes place in software development when a contributor/developer is ready to begin the process of moving new code changes into a main project repository. For example, a pull request can identify a code element that is being requested to be added to the codebase, where the pull request occurs before the code element is added to the codebase.

Known prior approaches focus on identifying vulnerabilities within the codebase as a whole, for example after new versions of code have been merged with the codebase, and do not detect issues with data accesses by individual code elements. In prior systems, administrative users manually review disclosures of protected data elements that are made by code developers. The labor-intensive nature of the manual review and resulting inconsistencies make it challenging for privacy teams and audit systems to ensure that protected data elements are protected (e.g., accessed in accordance with applicable guidelines or restrictions) across all use cases and only used for authorized processes. Manual reporting also makes it difficult to provide a complete and reliable audit at the code element level.

Aspects of the present disclosure address the above and other deficiencies by performing an automated privacy scan of a code element that has been requested, e.g., by a pull request, to be committed to a codebase. The privacy scan is performed before the code element is committed to the codebase. The privacy scan executes one or more queries that look for statements in the code element that indicate that the code element is accessing one or more protected data elements. As used herein, access or accessing includes, for example, a code element accessing, receiving, requesting, using, instantiating, invoking, referencing, etc., one or more protected data elements.

A protected data element, as used herein, incudes data items and computer programing structures such as application programming interface (API) calls, utility functions, data models, declarations, requests, field names, and references. Such a data element is considered protected if it accesses at least some data for which access is restricted, e.g., the data can only be used on an end user or device and cannot be shared with other devices. If any protected data element accesses are detected in a code element, a search of approved uses for the protected data element is performed, for example on a database of registered protected data elements.

By performing the search before the code element is committed to the codebase, traceability of the protected data element to the specific code element doing the access is provided. The code element-level traceability also enables approved uses of protected data elements to be customized for each user of an application. For example, some users may allow an online system to use their age or income information to generate product recommendations but may not permit use of such data for third party advertising, while other users may approve the use of age or income information for both product recommendations and third-party advertising purposes. Using the described approaches provides auditable control of accesses of protected data elements by individual code elements before those code elements are merged with a codebase.

This disclosure refers to examples that include user-oriented protected data elements, such as various elements of user-specific data. However, the disclosed approaches have broader application to other types of protected data elements, such as confidential business information, credential or privilege escalations, or other sensitive information. Additionally, the described approaches are not limited to uses within social media applications but can be employed to control and manage protected data elements in other types of application software systems.

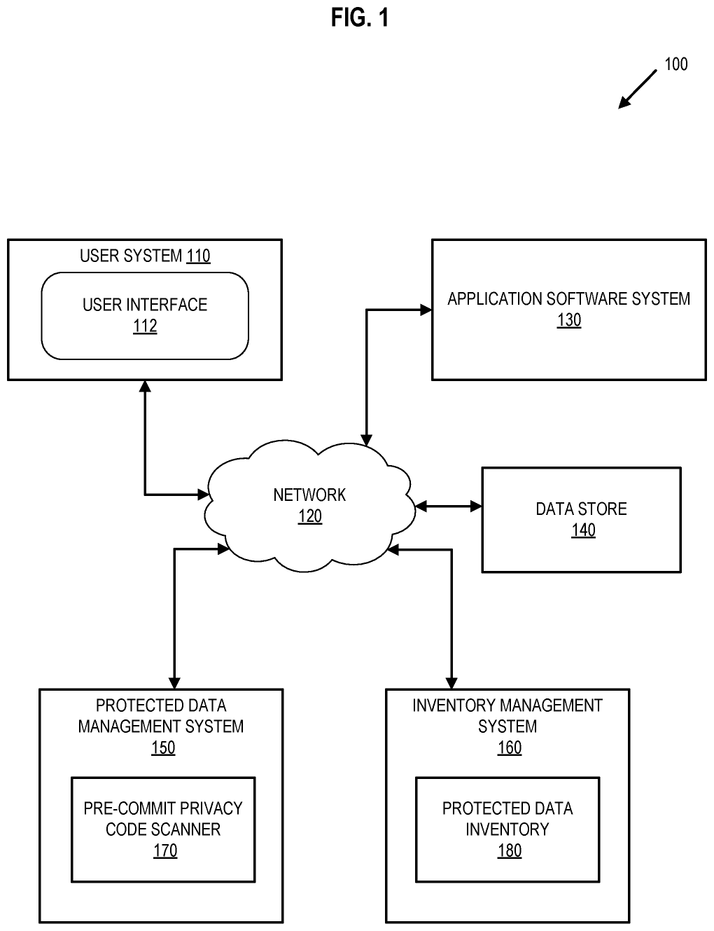

FIG. 1 illustrates an example computing system 100 that includes a protected data management system 150 and an inventory management system 160. In the embodiment of FIG. 1, computing system 100 includes a user system 110, a network 120, an application software system 130, a data store 140, protected data management system 150, and inventory management system 160. As described in more detail below, protected data management system 150 includes a pre-commit privacy code scanner 170 and inventory management system 160 includes a protected data inventory 180.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 can be or include a front-end portion of application software system 130. In some embodiments, the user system can include a software development application that receives input text or symbols that represent program code that can be executed on application software system 130 or user system 110.

User interface 112 is any type of user interface as described above. User interface 112 can be used to input search queries and view or otherwise perceive output that includes data produced by application software system 130. For example, user interface 112 can include a graphical user interface and/or a conversational voice/speech interface that includes a mechanism for entering a search query and viewing query results and/or other digital content. Examples of user interface 112 include web browsers, command line interfaces, and mobile apps. User interface 112 as used herein can include application programming interfaces (APIs).

Network 120 can be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

Application software system 130 is any type of application software system that includes or utilizes functionality provided by protected data management system 150. Examples of application software system 130 include but are not limited to connections network software, such as social media platforms, and systems that are or are not based on connections network software, such as general-purpose search engines, job search software, recruiter search software, sales assistance software, advertising software, learning and education software, or any combination of any of the foregoing.

A client portion of application software system 130 can operate in user system 110, for example as a plugin or widget in a graphical user interface of a software application or as a web browser executing user interface 112. In an embodiment, a web browser can transmit an HTTP request over a network (e.g., the Internet) in response to user input that is received through a user interface provided by the web application and displayed through the web browser. A server running application software system 130 and/or a server portion of application software system 130 can receive the input, perform at least one operation using the input, and return output using an HTTP response that the web browser receives and processes.

Data store 140 is a memory storage. Data store 140 stores, for example, protected data elements such as user data, financial data, and application data, as well as code elements and codebases. Portions of data store 140 are configured to be searchable so that data and/or code elements can be queried and retrieved for analysis or use. For example, portions of data store 140 can be configured as relational database, a graph database, a key value store, or an object oriented database. Data store 140 can reside on at least one persistent and/or volatile storage device that can reside within the same local network as at least one other device of computing system 100 and/or in a network that is remote relative to at least one other device of computing system 100. Thus, although depicted as being included in computing system 100, portions of data store 140 can be part of computing system 100 or accessed by computing system 100 over a network, such as network 120.

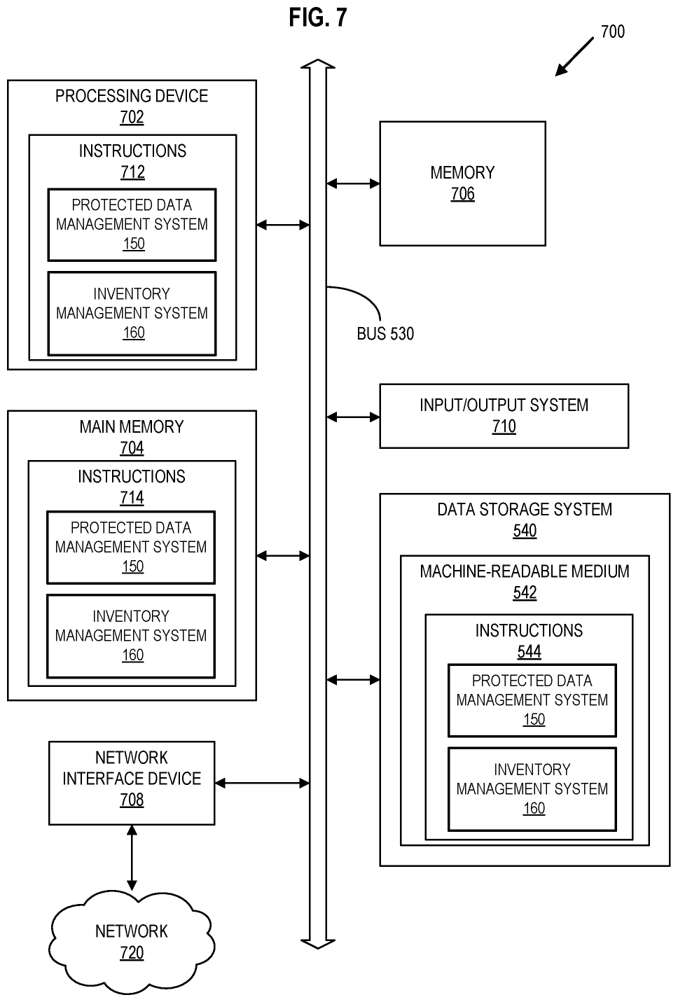

Protected data management system 150 is configured to receive inputs, such as code elements, repository identifiers, and branch identifiers, from the user system 110. In some embodiments, the application software system 130 includes at least a portion of the protected data management system 150. As shown in FIG. 7, the protected data management system 150 can be implemented as instructions stored in a memory, and a processing device 702 can be configured to execute the instructions stored in the memory to perform the operations described herein.

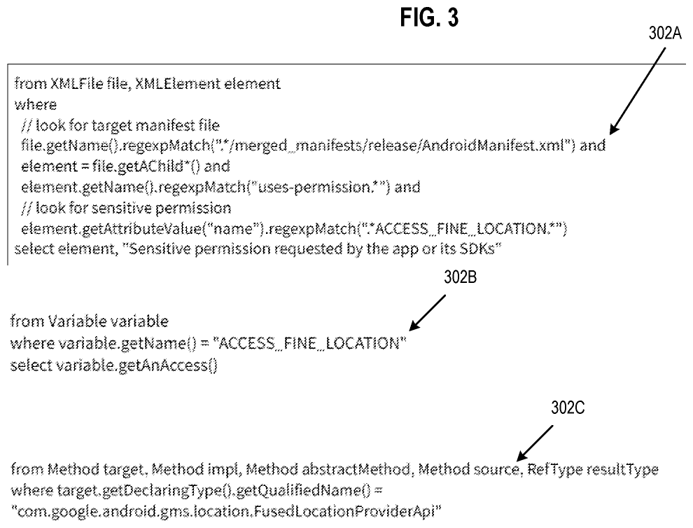

In operation, protected data management system 150 receives as input a pull request for a code element, a repository identifier, and a branch identifier, such as a portion of a software application being submitted for inclusion in a codebase of a software development environment. In response to receiving the pull request, the protected data management system 150 applies a pre-commit privacy code scanner 170 to the code element identified by the pull request. The pre-commit privacy code scanner 170 executes one or more queries on the contents of the code element (e.g., the programming statements and other text that make up the code element) to identify any accesses of protected data elements that are performed by the code element during an execution of the code element by a processor. The query is designed to identify a particular type of protected data element and/or protected data element access. Additional details and examples of queries that can be executed by pre-commit privacy code scanner 170 on code elements are described below with reference to FIG. 3. If the pre-commit privacy code scanner 170 identifies one or more protected data elements and/or protected data element accesses, the protected data management system 150 requests an authorization from the inventory management system 160.

The inventory management system 160 is configured to register protected data elements and/or protected data element accesses and to authorize inclusion of protected data elements and/or protected data element accesses in a codebase, e.g., for execution by application software system 130. The inventory management system 160 includes protected data inventory 180.

Protected data inventory 180 includes, for example, a database of relationships between protected data elements and corresponding code elements that access or use the protected data element. In response to receiving a request from the protected data management system 150, the inventory management system 160 searches the protected data inventory 180 for the protected data element and/or protected data element access.

In one example, the inventory management system 160 identifies a match between the protected data element and/or protected data element access and a registered entry (e.g., a phone number field matches a registered use of phone number data) contained in the protected data inventory 180. Using the match between the protected data element and/or protected data element access and the registered entry, the code element corresponding to the protected data element and/or protected data element access is compared to a registered code entry associated with the registered entry. If the inventory management system 160 identifies a match for the code element, the code element has previously been authorized to use the protected data element and/or protected data element access by a previous registration process.

In another example, in response to receiving a request from the protected data management system 150, the inventory management system 160 searches the protected data inventory 180 for the protected data element and/or protected data element access. In this example, the inventory management system 160 does not identify a match between the protected data element and/or protected data element access and a registered entry (e.g., search of a birthday field does not return any matches) of the protected data inventory 180.

After determining that there is not a match between the protected data element and/or protected data element access and a registered entry, the code element is not committed to the codebase. The inventory management system 160 returns an indication representing no matches for the code element to the protected data management system 150. If the inventory management system 160 does not identify a match for the code element, the code element is not authorized to use the protected data element and/or protected data element access until completion of registration and approval. To initiate the registration and approval process, a notification is generated by the protected data management system 150 to the user system 110, the notification including a request to register the code element and the identified protected data element and/or protected data element access. By performing registration, the code element and the associated use of the protected data element is inserted into the protected data inventory. Additional details of the registration of code elements are described below.

While not specifically shown, it should be understood that any of user system 110, application software system 130, data store 140, protected data management system 150, and inventory management system 160 includes an interface embodied as computer programming code stored in computer memory that when executed causes a computing device to enable bidirectional communication with any other of user system 110, application software system 130, data store 140, protected data management system 150, and inventory management system 160 using a communicative coupling mechanism. Examples of communicative coupling mechanisms include network interfaces, inter-process communication (IPC) interfaces and APIs.

Each of user system 110, application software system 130, data store 140, protected data management system 150, and inventory management system 160 is implemented using at least one computing device that is communicatively coupled to electronic communications network 120. Any of user system 110, application software system 130, data store 140, protected data management system 150, and inventory management system 160 can be bidirectionally communicatively coupled by network 120. User system 110 as well as one or more different user systems (not shown) can be bidirectionally communicatively coupled to application software system 130.

A typical user of user system 110 can be an administrator or end user of application software system 130, protected data management system 150, and/or inventory management system 160. User system 110 is configured to communicate bidirectionally with any of application software system 130, data store 140, protected data management system 150, and/or inventory management system 160 over network 120.

The features and functionality of user system 110, application software system 130, data store 140, protected data management system 150, and inventory management system 160 are implemented using computer software, hardware, or software and hardware, and can include combinations of automated functionality, data structures, and digital data, which are represented schematically in the figures. User system 110, application software system 130, data store 140, protected data management system 150, and inventory management system 160 are shown as separate elements in FIG. 1 for ease of discussion but the illustration is not meant to imply that separation of these elements is required. The illustrated systems, services, and data stores (or their functionality) can be divided over any number of physical systems, including a single physical computer system, and can communicate with each other in any appropriate manner. Also, while depicted as separate components in FIG. 1, the protected data management system 150 and the inventory management system 160 may be executed by the same computing device or cloud computing environment. At least a portion of the protected data management system 150 or the inventory management system 160 are executable on the same device, on different devices, or across multiple devices.

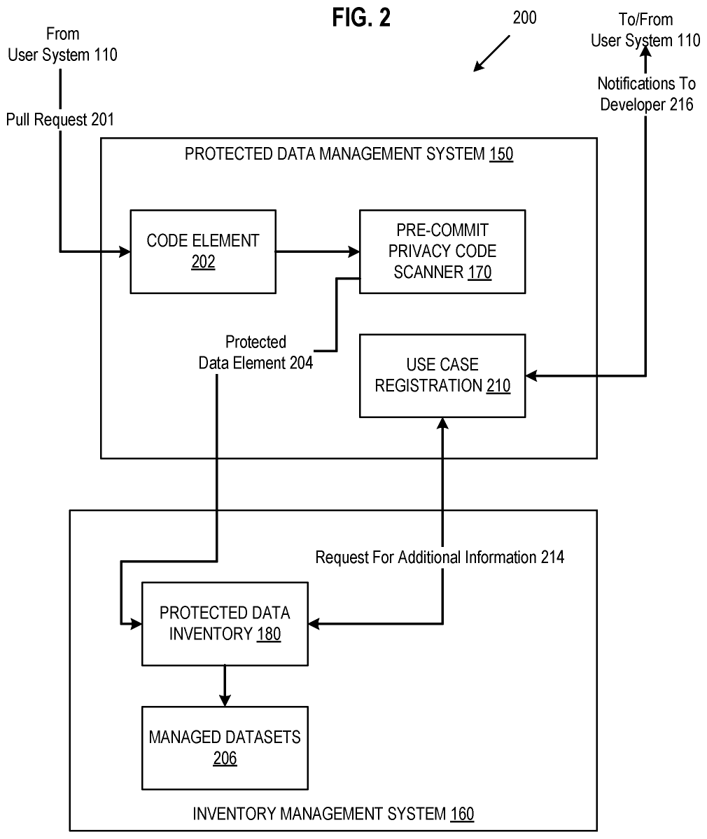

FIG. 2 is a flow diagram of an example method 200 to identify code that accesses a protected data element, in accordance with some embodiments of the present disclosure. In some embodiments, a code developer executed on the user system 110, such as described above with reference to FIG. 1, communicates a code element 202 to the protected data management system 150. The protected data management system 150 receives a pull request 201 that includes or identifies a code element 202 from the user system 110 and applies the pre-commit privacy code scanner 170 to the code element 202. The pull request 201 includes a request to include (e.g., commit or merge) the code element into a codebase of a software application. However, FIG. 2 does not show a commit because the operations shown in FIG. 2 include an approval process that occurs prior to the commit. For example, the pull request 201 is received from the developer's machine and identifies the code element 202 (e.g., pull request 201 could be a result of a developer attempting to add a new function to an application).

In some embodiments, the user system 110 generates the pull request 201 using a software development application or tool being executed on the user system 110 by a code developer (e.g., a user with credentials to submit pull requests). The pull request 201 submitted by the code developer identifies a code element 202, which is scanned by pre-commit privacy code scanner 170 for portions of code that access protected data element 204. Protected data element 204 includes or accesses sensitive data of end-users or end user devices of the online system, for example.

As described with reference to FIG. 1, the pre-commit privacy code scanner 170 applies one or more queries to the code element 202. The pre-commit privacy code scanner 170 is configured to identify protected data element 204 and/or accesses of protected data element 204. In some embodiments, the pre-commit privacy code scanner 170 accesses a database of queries and executes each of the queries in the database. Each query searches the code element for portions of code that access or use the identified protected data element 204. Each query can detect portions of the code element that, for example, make an API (application programming interface) call to a data server, such as data store 140, include a function call to an operating system of the user system, or identify or reference a sensitive field in a form that requests data from a user. An API call to the data store 140 includes, for example, a request for information stored in the data store 140, such as user data, as described above. A function call to the operating system of the user system 110 includes, for example, a request for geolocation data, phonebook data, application inventory of other applications on the user system, or access to an input or output device of the user system 110, such as a camera, microphone, or health measurement sensors.

The queries use, for example, string matching, regular expression matching, or tokenized pattern matching to find protected data element accesses within code elements. Other examples of types of protected data element accesses that a query or query may be configured to search for in code elements include, for example, a sensitive permission declaration, a run-time request for permission to access a protected data element, an access to a variable having a variable name that matches a name of a protected data element, a sensitive data model that stores one or more protected data elements, a reference to a sensitive data model, a declaration of a sensitive data model, a use of a sensitive data model, a class that instantiates a sensitive data model as a local variable or parameter, a sensitive application programming interface (API) that accesses one or more protected data elements, a utility function that transitively invokes a sensitive API, or an invocation of a sensitive API. What constitutes a “sensitive” data element, declaration, instantiation, data model, etc., can be defined expressly in the query (e.g., using a regular expression), or by a rules engine, or based on machine learning model output, for example. Additional details of query examples are described with reference to FIG. 3.

The pre-commit privacy code scanner 170 communicates protected data element 204 (if any are identified) from the code element 202 to the inventory management system 160. In some embodiments, the pre-commit privacy code scanner 170 communicates protected data element 204 to the inventory management system 160. The protected data element 204 identifies the access-restricted data used or accessed by the code element 202 and includes other information such as a type of data detected by the query that identified the protected data element 204.

The inventory management system 160 searches the protected data inventory 180 to determine if the protected data element 204 has a match in the protected data inventory 180. If the inventory management system 160 determines that the protected data element 204 has a match, the inventory management system 160 searches a set of managed datasets 206 to verify that the protected data element 204 is restricted within each managed dataset of the managed datasets 206. If the inventory management system 160 determines that the protected data element 204 does not have a match in the set of managed datasets or otherwise, the inventory management system 160 communicates a request for additional information 214, which indicates no match is registered, to the protected data management system 150.

As described above with reference to FIG. 1, if the inventory management system 160 does not identify a match, the code element 202 is not authorized to access or use the protected data element 204. To authorize a code element, the protected data management system 150 generates a use case registration 210 in response to the request for additional information 214. The use case registration 210 initiates the approval process to authorize the code element 202's access or use of the protected data element 204.

The use case registration 210 includes, for example, a fill-in form (e.g., one or more graphical user interface elements) that is provided to the user system 110 for presentation to the code developer through a user interface. In some embodiments, the use case registration 210 generates a notification to the developer 216 of the code element 202 that requests input corresponding to the request for additional information 214. The use case registration 210 requests the developer provide, for example, a purpose, a citation of an authority for use, a code development team responsible for the code element 202, at least one dataset identifier, and/or additional details for the access of the protected data element 204 in response to the request for additional information 214. An example of the citation of an authority for use is a reference to a rule, regulation, policy, or other source of permission.

The protected data management system 150 can receive the response including the additional information from the developer of the code element 202. The protected data management system 150 validates the completed use case registration 210 to authorize or deny registration of the code element 202. In some embodiments, the protected data management system 150 generates an approval sequence of tasks for reviewers who each recommend authorization or denial of the registration. The protected data management system 150 can authorize or deny the registration of the code element using a majority of recommendations of the reviewers (e.g., 3 recommend authorization, 1 recommend denial). In other embodiments, the protected data management system 150 can apply a decision tree or other type of machine learning to generate an authorization using a classification of a sensitivity level of the protected data element 204 and the additional information included in the use case registration 210.

If the protected data management system 150 authorizes the code element 202 using the use case registration 210, the protected data management system 150 communicates the use case registration and an authorization code to the inventory management system 160. The inventory management system 160 inserts the protected data element 204 and information from the use case registration 210 (e.g., purpose, citation of authority, data owner, or dataset identifier) into the protected data inventory 180. After the protected data element 204 and information from the use case registration 210 is inserted into the protected data inventory 180, the code element 202 is committed to the codebase as described above with reference to FIG. 1. If the protected data management system 150 denies authorization of the code element 202 using the use case registration 210, the protected data management system 150 communicates the denial to the user system 110. After the protected data element 204 and information from the use case registration 210 are denied, the code element 202 is prevented from being committed to the codebase and the developer is notified through the user system 110.

While FIG. 2 is described with only one code element 202, the protected data management system 150 can scan and authorize or deny any number of code elements 202 simultaneously, such as in a cloud or distributed software development environment where multiple code elements 202 are being processed concurrently.

FIG. 3 illustrates examples of queries that identify protected data elements, in accordance with some embodiments of the present disclosure. As described above with reference to FIGS. 1-2, queries 302A, 302B, and 302C, collectively “queries 302” are executed by the pre-commit privacy code scanner 170 to detect protected data elements used by code elements in or identified by a commit request for inclusion in a codebase. In some embodiments, the queries 302 are configured to detect privacy data of a user system 110 operated by a user that accesses the application software system 130 with an account that has non-administrative user permissions. For example, the user with non-administrative user permissions interacts with the application software system 130 and provides various data that is stored in data store 140.

As illustrated by FIG. 3, query 302A is configured to detect a sensitive permission request by the code element. Query 302A detects that the code element requests a precision location from an operating system. In this example, query 302A is searching for a regular expression match to the API call “ACCESS_FINE_LOCATION” which is used to request precision location data from an onboard sensor such as GPS. Additionally, query 302A is designed to detect any request to access the precision location data as a subordinate request to the code element 202 (e.g., a child statement to the code element 202).

In FIG. 3, query 302B is configured to detect sensitive data by searching for variable names representing sensitive data in the code element. Query 302B detects that the code element includes an API invocation requiring operating system permission named “ACCESS_FINE_LOCATION” and subsequently requests access to the variable.

As further illustrated by FIG. 3, query 302C is configured to detect sensitive data by searching for a target location in the code element that represents a sensitive data target. Query 302C detects that the code element includes a target that is a service that provides sensitive data. In this example, the target is a location provider API.

In some embodiments, the queries 302 each include a set of attributes or metadata. In some implementations, each query's attributes or metadata indicate a priority level for the query and an output detail level associated with the query. For instance, a query can each be assigned a priority level in accordance with the sensitive nature of the type of data identified by the query and a level of output detail that describes how much information should be reported about the sensitive data that after detection.

The priority level is used, for instance, to determine whether to generate a notification or not. For example, a high priority level maps to logic for activating an alert while a low priority level maps to logic that generates a report but does not activate an alert. The output level of detail is used, for example, to determine how much information about a particular protected data element and/or protected data element access is included in a notification, report, or alert. The output level of detail can be defined, for example, at the instance level (e.g., every occurrence of the protected data element is reported in the output), at the class level (e.g., if a class includes the protected data element, it is included in the output), or at the package level (e.g., if one or more accesses of a protected data element occur anywhere in a software application, library, etc., it is reported in the output). Returning to the example above, the geographic location for the device of the end user may be classified as high priority, thereby automatically activating an alert upon detection in a code element. In another example, a device identifier such as a serial number, a network address, an International Mobile Equipment Identity, a model number, or an Embedded Identity Document is classified as lower priority, and the detection is included in a report but no alert is activated. In this way, implementations of the described query structure can be configured to avoid overwhelming a developer or review team with too many auto-generated alerts.

The generation of notifications as described above can be customized using the priority level. As shown in Table 1 below, each priority level of high, medium, and low includes or is associated with different attributes. As shown below, a notification may be generated for high priority queries that detect protected data elements and/or protected data element accesses at the instance level with a severity level of a warning. As an example, for a query that detects an occurrence (e.g., an instance) of an access or request for access to the precise geographic location of the device of the end-user as described above, the priority level is high, the notification is generated, the severity level is a warning, and the level of detail in the notification is for each instance (e.g., an alert is activated every time a code element is detected as containing a geolocation access request). In the examples of Table 1, no notifications are generated for medium and low priority levels, but a recommendation to the developer or the review team may be surfaced at a later time, such as in an aggregate report. Additionally, for the lower priority levels, the level of detail included in the report is at a higher level of granularity (e.g., fewer details are included in reports for lower priority levels, and more details are reported for higher priority levels).

TABLE 1

| Priority | Notification | Severity Level | Level of Detail |
|---|---|---|---|
| High | Generated | Warning | Instance |
| Medium | Not generated | Recommendation | Class |
| Low | Not generated | Recommendation | Package |

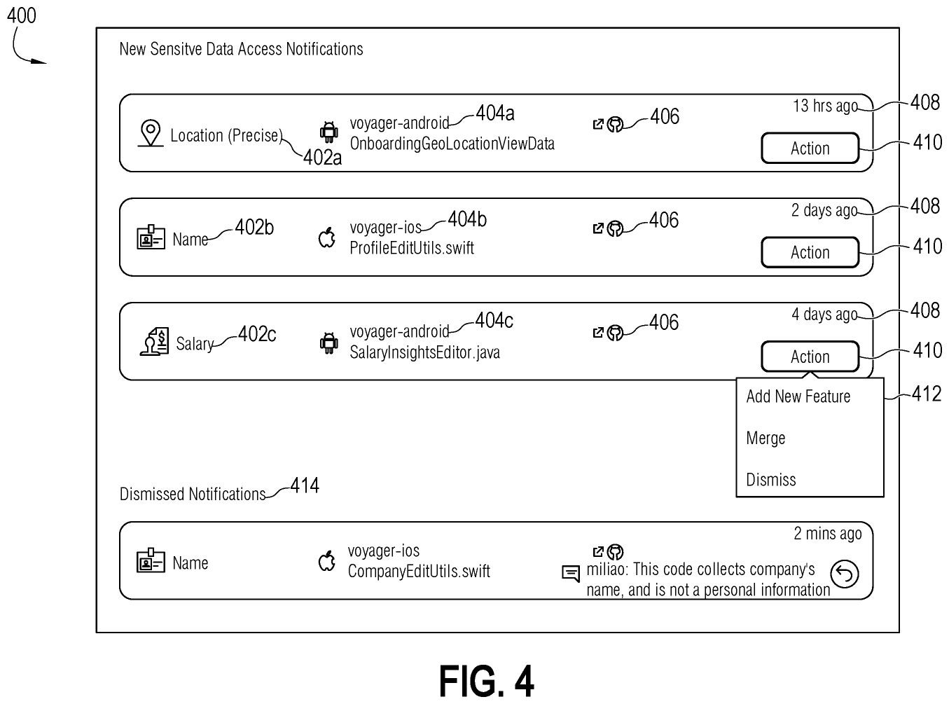

FIG. 4 is an example of a user interface that includes notifications of detected protected data elements in the codebase, in accordance with some embodiments of the present disclosure. As described above with reference to FIGS. 1-2, if the protected data management system 150 determines that the code element uses a protected data element that has no match in the protected data inventory 180, the protected data management system 150 generates a notification that can be displayed on a user interface 400 as illustrated in FIG. 4. The user interface 400 identifies the detected protected data elements 402a-c, collectively “protected data elements 402,” the code repository name 404a-c of the code element, collectively “code repository name 404,” a repository link 406, a timeliness metrics 408a-c, and an action control element 410.

In the example illustrated by FIG. 4, the protected data management system 150 has generated three notifications for protected data elements 402 for an approval process that requests action from at least one reviewer. The protected data elements 402 include precision geolocation, legal name of a person, and salary data relating to the person. Each of these protected data elements 402 are detected by applying a query as described above to a code element. The code repository name 404 indicates a particular software configuration such as ANDROID, IOS, LINUX, or other operating system associated with the code element in which the protected data element was detected. The repository link 406 is a hyperlink to the source code of the code element that is stored in a repository, e.g., the development repository, before the code element is committed to, e.g., the production codebase. The timeliness metrics 408a-c indicate an elapsed time since the generation of the notification.

In some embodiments, the timeliness metrics 408a-c are used to prioritize display of the notifications by presenting the notification with the longest time interval presented for prioritization by reviewers in the approval process. The action control element 410 when selected provides a reviewer with a set of selectable approval actions 412. In the illustrated example, the selectable approval actions 412 include add new feature, merge, and dismiss. Add new feature if selected causes the system to authorize the use case of the code element and add the use case to the protected data element inventory. Merge merges the use case with an existing use case for an existing code element, and dismiss logs the use case as disapproved. When a use case is dismissed, the associated code element is not added to the codebase or merged with any other code elements. An example of a notification of a dismissed use case is shown in the dismissed notifications section 414.

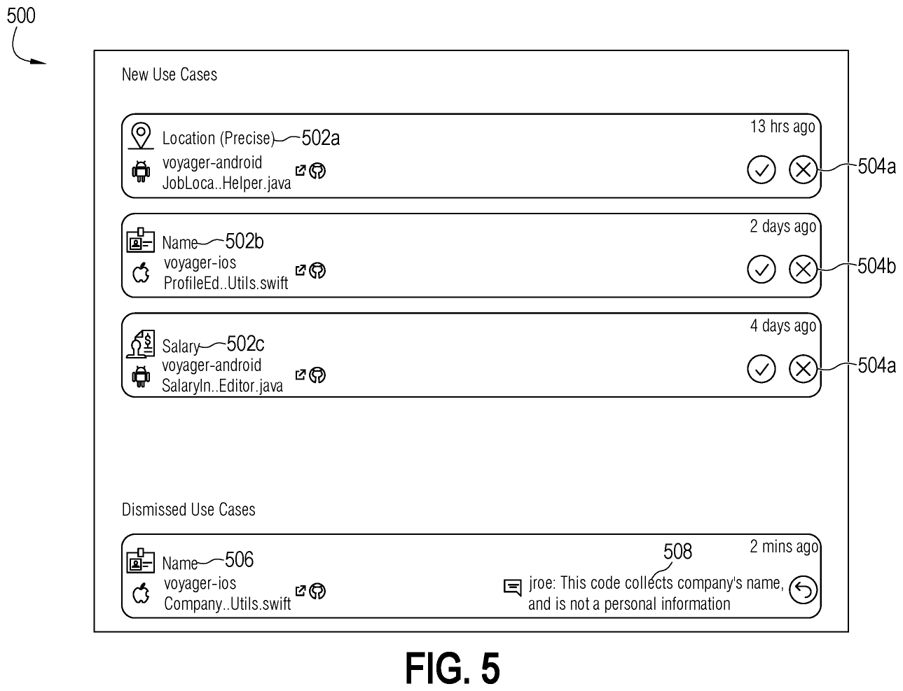

FIG. 5 is an example of a user interface that provides a registration process for a protected data element in the codebase, in accordance with some embodiments of the present disclosure. As illustrated by FIG. 5, the user interface receives use cases 502a-502c requesting to register use of protected data elements as described above with reference to FIG. 4.

In some embodiments, the use cases 502a-502c are presented in the user interface to a reviewer. The user interface receives a selection of an approval/disapproval action 504a-504c for each of the corresponding use cases 502a-c. A reviewer selects approval/disapproval action 504a to authorize insertion of each use case 502a-c into the database of registered protected data elements as described above with reference to FIGS. 1-4. In response to a disapproval of a use case, such as denied use case 506, the user interface moves the denied use case to a separate portion of the user interface that indicates that the denied use case has received an approval/disapproval action. In some embodiments, the reviewer inputs a comment 508 that contains feedback to the developer.

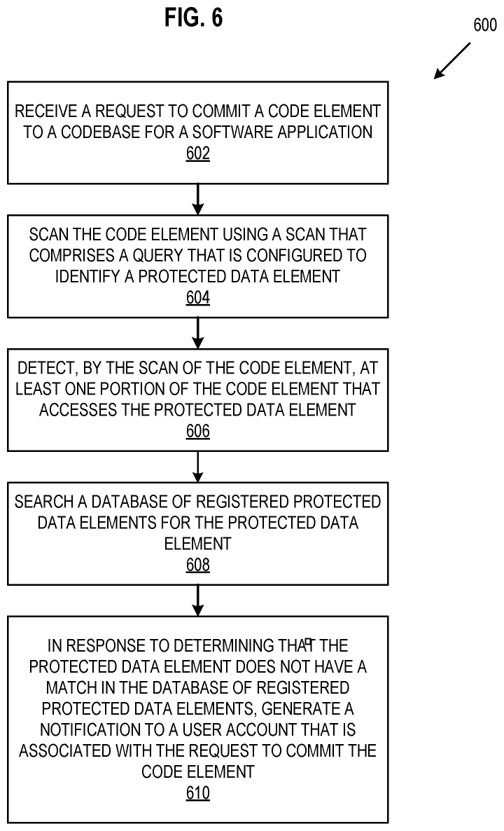

FIG. 6 is a flow diagram of an example method 600 of detecting protected data element in a codebase and managing protected data elements, in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the protected data management system 150 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 602, the protected data management system 150 receiving a request to commit a code element to a codebase for inclusion in a software application. For example, the protected data manager receives a pull request for a code element for inclusion in a codebase of a software development environment. As described above, a pull request is a request in a software development environment that takes place in software development when a developer requests to include a code element into the codebase of a software application.

At operation 604, the protected data management system 150 scans the code element using queries that are customized to identify protected data elements. The protected data management system 150 applies a pre-commit privacy code scanner 170 to the code element identified by the pull request. Each query is applied to the code element to identify a particular type of protected data element. The queries can be applied as string matching, regular expression matching, or using machine learning to identify protected data in the code element.

At operation 606, the protected data management system 150 detects, by the scan of the code element, at least one portion of the code element that accesses the protected data element. For example, the pre-commit privacy code scanner 170 identifies at least one protected data element using at least one of the queries as described above at operation 604. In response to detecting the protected data elements in the code element, the protected data management system 150 requests an authorization from the inventory management system 160.

At operation 608, the inventory management system 160 searches a database of registered protected data elements for the protected data element. The inventory management system 160 performs the search in response to receiving a request from the protected data management system 150. In some embodiments, the inventory management system 160 identifies a match between the protected data element and at least one registered entry of the protected data inventory 180. Using the match between the protected data element and a registered entry, the code element is authorized and committed to the codebase. In other embodiments, the inventory management system 160 does not identify a match between the protected data element and a registered entry of the protected data inventory 180. After determining that there is not a match between the protected data element and a registered entry, the code element is not committed to the codebase. The inventory management system 160 returns an indication representing no matches for the code element to the protected data management system 150.

At operation 610, the protected data management system 150 generates a notification to a user account that is associated with the request to commit the code element in response to determining that the protected data element does not have a match in the database of registered protected data elements. A notification is generated by the protected data management system 150 to the user system 110, the notification including a request to register the code element and the identified protected data element. By performing registration, the code element and the use of the protected data element is processed with an additional scan to validate that detected protected data elements are registered. After validation, the code element is authorized for committing to the codebase.

FIG. 7 illustrates an example machine of a computer system 700 within which a set of instructions, for causing the machine to perform any one or more of the methodologies discussed herein, can be executed. In some embodiments, the computer system 700 can correspond to a component of a networked computer system (e.g., the computer system 100 of FIG. 1) that includes, is coupled to, or utilizes a machine to execute an operating system to perform operations corresponding to the protected data management system 150 of FIG. 1. The machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment. While depicted as a single computer system 700 in FIG. 7, the protected data management system 150 and the inventory management system 160 may be executed by the same computer system 700 or as part of a networked computer system such as depicted in FIG. 1. At least a portion of the protected data management system 150 or the inventory management system 160 are executable on the same, on different devices, or across multiple devices.

The machine can be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a memory 706 (e.g., flash memory, static random access memory (SRAM), etc.), an input/output system 710, and a data storage system 740, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 712 for performing the operations and steps discussed herein.

The computer system 700 can further include a network interface device 708 to communicate over the network 720. Network interface device 708 can provide a two-way data communication coupling to a network. For example, network interface device 708 can be an integrated-services digital network (ISDN) card, cable modem, satellite modem, or a modem to provide a data communication connection to a corresponding type of telephone line. As another example, network interface device 708 can be a local area network (LAN) card to provide a data communication connection to a compatible LAN. Wireless links can also be implemented. In any such implementation network interface device 708 can send and receive electrical, electromagnetic or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic or optical signals that carry digital data to and from computer system computer system 700.

Computer system 700 can send messages and receive data, including program code, through the network(s) and network interface device 708. In the Internet example, a server can transmit a requested code for an application program through the Internet and network interface device 708. The received code can be executed by processing device 702 as it is received, and/or stored in data storage system 740, or other non-volatile storage for later execution.

The input/output system 710 can include an output device, such as a display, for example a liquid crystal display (LCD) or a touchscreen display, for displaying information to a computer user, or a speaker, a haptic device, or another form of output device. The input/output system 710 can include an input device, for example, alphanumeric keys and other keys configured for communicating information and command selections to processing device 702. An input device can, alternatively or in addition, include a cursor control, such as a mouse, a trackball, or cursor direction keys for communicating direction information and command selections to processing device 702 and for controlling cursor movement on a display. An input device can, alternatively or in addition, include a microphone, a sensor, or an array of sensors, for communicating sensed information to processing device 702. Sensed information can include voice commands, audio signals, geographic location information, and/or digital imagery, for example.

The data storage system 740 can include a machine-readable storage medium 742 (also known as a computer-readable medium) on which is stored one or more sets of instructions 744 or software embodying any one or more of the methodologies or functions described herein. The instructions 744 can also reside, completely or at least partially, within the main memory 704 and/or within the processing device 702 during execution thereof by the computer system 700, the main memory 704 and the processing device 702 also constituting machine-readable storage media.

In one embodiment, the instructions 744 include instructions to implement functionality corresponding to a protected data manager (e.g., the protected data management system 150 of FIG. 1). While the machine-readable storage medium 742 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Illustrative examples of the technologies disclosed herein are provided below. An embodiment of the technologies may include any of the examples or a combination of the described below.

In an example 1, a method includes receiving a request to commit a code element to a codebase for a software application; prior to committing the code element to the codebase, scanning the code element using an automated scan; the scan comprises a query that is configured to identify, in the code element, at least one protected data element access; detecting, by the scan of the code element, at least one portion of the code element that contains the at least one protected data element access; searching a database of registered protected data elements for the at least one protected data element access; determining that the at least one protected data element access does not have a match in the database of registered protected data elements; and prior to committing the code element to the codebase, generating and sending a notification to a developer account associated with the request to commit the code element.

An example 2 includes the subject matter of example 1, where the protected data element access include a statement that accesses personally identifiable information of an end user of the software application or privileged data of a device associated with the end user. An example 3 that includes the subject matter of example 1 or example 2, where the notification comprises an indication to the developer account that the protected data element access is not authorized for inclusion in the software application. An example 4 includes the subject matter of any of examples 1-3 and further includes requesting, from the developer account, additional information relating to the protected data element access, the additional information including at least one of a purpose of the protected data element access, a citation to a source of permission to use the protected data element access, or an intended use of the protected data element access; and generating an approval process for the protected data element access based on the additional information. An example 5 includes the subject matter of any of examples 1˜4 and further includes inserting data relating to the protected data element access and at least one of the purpose, the citation, or the intended use of the protected data element access into the database of registered protected data elements; and committing the code element into the codebase. An example 6 includes the subject matter of any of examples 1-5 and further includes denying insertion of the data relating to the protected data element access into the database of registered protected data elements based on a response received from the developer account; and at least temporarily preventing the committing of the code element into the codebase. An example 7 includes the subject matter of any of examples 1-6 where the query includes at least one of: a priority level usable to determine at least one of (i) whether to generate the notification or (ii) what type of notification to generate; or an output level of detail that determines how much information is included in the notification. An example 8 includes the subject matter of any of examples 1-7, where generating and sending the notification to the developer account includes filtering the queries by the priority level such that notifications for queries having a priority level below a threshold priority level are not sent to the developer account. An example 9 includes the subject matter of any of examples 1-8, where wherein searching the database of registered protected data elements for the protected data element access includes generating a comparison of metadata in the database of registered protected data elements with corresponding metadata of the protected data element access; and determining, using the comparison, whether at least one entry in the database of registered protected data elements matches the protected data element. An example 10 includes the subject matter of any of examples 1-9, where the query is configured to identify at least one of a sensitive permission declaration, a run-time request for permission to access a protected data element, an access to a variable having a variable name that matches a name of a protected data element, a sensitive data model that stores one or more protected data elements, a reference to a sensitive data model, a declaration of a sensitive data model, a use of a sensitive data model, a class that instantiates a sensitive data model as a local variable or parameter, a sensitive application programming interface (API) that accesses one or more protected data elements, a utility function that transitively invokes a sensitive API, or an invocation of a sensitive API. An example 11 includes the subject matter of any of examples 1-10 where determining, using the comparison, whether at least one entry in the database of registered protected data elements matches the protected data element access includes comparing the protected data element access to a purpose of use of the protected data element contained in the database; determining that the protected data element access and the purpose of use of the protected data element contained in the database match; and committing the code element into the codebase.

In an example 12, a system includes at least one memory device; and a processing device, operatively coupled to the at least one memory device, to: receive a request to commit a code element to a codebase for a software application; scan the code element using a scan that comprises a query that is customized to identify a protected data element; detect, by the scan of the code element, at least one portion of the code element that accesses the protected data element; search a database of registered protected data elements for the identified protected data element; and in response to determining that the identified protected data element does not have a match in the database of registered protected data elements, generate a notification to a developer account that is associated with the request to commit the code element.

An example 13 includes the subject matter of example 12 where the protected data element comprises personally identifiable information of an end user of the software application or privileged data of a device associated with the end user. An example 14 includes the subject matter of example 12 or 13, where the notification includes an indication to the developer account that the protected data element is not authorized for inclusion in the software application. An example 15 includes the subject matter of any of examples 12-14, where the processing device is further caused to: request, from the developer account, additional information relating to the protected data element, the additional information including at least one of a purpose of use of the protected data element, a citation to a source of permission to use the protected data element, or an intended use of the protected data element; and generate an approval process using the protected data element and the additional information. An example 16 includes the subject matter of any of examples 12-15 where the processing device is further caused to: insert the protected data element and at least one of the purpose, the citation, or intended use of the protected data element into the database of registered protected data elements; and commit the code element into the codebase. An example 17 includes the subject matter of any of examples 12-16 where the processing device is further caused to: based on a response received from the developer account, deny insertion an entry for the protected data element into the database of registered protected data elements; and at least temporarily prevent the commitment of the code element into the codebase. An example 18 includes the subject matter of any of examples 12-17 where the processing device is further caused to: receive, by a machine learning model, a set of training queries and a set of training protected data elements; and train the machine learning model to generate at least one query based on a data set including at least one protected data element. An example 19 includes the subject matter of any of examples 12-18 where to search a database of registered protected data elements for the protected data element, the processing device is further caused to: compare a metadata of each entry in the database of registered protected data elements with corresponding metadata of the protected data element; and determine, using the comparison, if at least one entry in the database of registered protected data elements matches the protected data element. An example 20 includes the subject matter of any of examples 12-19 where the query is configured to identify at least one of a sensitive permission declaration, a run-time request for permission to access a protected data element, an access to a variable having a variable name that matches a name of a protected data element, a sensitive data model that stores one or more protected data elements, a reference to a sensitive data model, a declaration of a sensitive data model, a use of a sensitive data model, a class that instantiates a sensitive data model as a local variable or parameter, a sensitive application programming interface (API) that accesses one or more protected data elements, a utility function that transitively invokes a sensitive API, or an invocation of a sensitive API.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100, can carry out the computer-implemented method 500 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

Illustrative examples of the technologies disclosed herein are provided below. An embodiment of the technologies may include any of the examples or a combination of the described below.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving a request to commit a code element to a codebase for a software application;
prior to committing the code element to the codebase, scanning the code element using an automated scan;
the scan comprises at least one query that is configured to identify, in the code element, at least one protected data element access;
detecting, by the scan of the code element, at least one portion of the code element that contains the at least one protected data element access;
searching a database of registered protected data elements for the at least one protected data element access;
determining that the at least one protected data element access does not have a match in the database of registered protected data elements; and
prior to committing the code element to the codebase, generating and sending a notification to a developer account associated with the request to commit the code element.

2. The method of claim 1, wherein the protected data element access comprises a programming statement that at least one of (i) accesses personally identifiable information of an end user of the software application or (ii) accesses privileged data of a device associated with the end user.

3. The method of claim 1, wherein the notification comprises an indication to the developer account that the protected data element access is not authorized for inclusion in the software application.

4. The method of claim 3 further comprising:
requesting, from the developer account, additional information relating to the protected data element access, the additional information including at least one of a purpose of the protected data element access, a citation to a source of permission to use the protected data element access, or an intended use of the protected data element access; and
generating an approval process for the protected data element access based on the additional information.

5. The method of claim 4, further comprising:
inserting data relating to the protected data element access and at least one of the purpose, the citation, or the intended use of the protected data element access into the database of registered protected data elements; and
committing the code element into the codebase.

6. The method of claim 4, further comprising:
based on a response received from the developer account, denying insertion of the additional information relating to the protected data element access into the database of registered protected data elements; and
at least temporarily preventing the committing of the code element into the codebase.

7. The method of claim 1, wherein the query comprises at least one of:
a priority level usable to determine at least one of (i) whether to generate the notification or (ii) what type of notification to generate; or (iii) an output level of detail that determines how much information about the protected data element access is included in the notification.

8. The method of claim 7, wherein generating and sending the notification to the developer account comprises:
filtering the queries by the priority level such that notifications for queries having a priority level below a threshold priority level are not sent to the developer account.

9. The method of claim 1, wherein searching the database of registered protected data elements for the protected data element access comprises:
generating a comparison of metadata in the database of registered protected data elements with corresponding metadata of the protected data element access; and
determining, using the comparison, whether at least one entry in the database of registered protected data elements matches the protected data element access.

10. The method of claim 9, wherein the at least one query is configured to identify at least one of a sensitive permission declaration, a run-time request for permission to access a protected data element, an access to a variable having a variable name that matches a name of a protected data element, a sensitive data model that stores one or more protected data elements, a reference to a sensitive data model, a declaration of a sensitive data model, a use of a sensitive data model, a class that instantiates a sensitive data model as a local variable or parameter, a sensitive application programming interface (API) that accesses one or more protected data elements, a utility function that transitively invokes a sensitive API, or an invocation of a sensitive API.

11. The method of claim 9, wherein determining, using the comparison, whether at least one entry in the database of registered protected data elements matches the protected data element access comprises:
comparing the protected data element access to a purpose of use of the protected data element access stored in the database;
determining that the protected data element access matches the purpose of use of the protected data element access stored in the database; and
committing the code element into the codebase.

12. A system comprising:
at least one memory device; and
a processing device, operatively coupled to the at least one memory device, to:
receive a request to commit a code element to a codebase for a software application;
scan the code element using a scan that comprises a query that is customized to identify a protected data element;
detect, by the scan of the code element, at least one portion of the code element that accesses the protected data element;
search a database of registered protected data elements for the protected data element; and
in response to determining that the protected data element does not have a match in the database of registered protected data elements, generate a notification to a developer account that is associated with the request to commit the code element.

13. The system of claim 12, wherein the protected data element comprises personally identifiable information of an end user of the software application or privileged data of a device associated with the end user.

14. The system of claim 12, wherein the notification includes an indication to the developer account that the protected data element is not authorized for inclusion in the software application.

15. The system of claim 12, wherein the processing device is further caused to:
request, from the developer account, additional information relating to the protected data element, the additional information including at least one of a purpose of use of the protected data element, a citation to a source of permission to use the protected data element, or an intended use of the protected data element; and
generate an approval process using the protected data element and the additional information.

16. The system of claim 15, wherein the processing device is further caused to:
insert the protected data element and at least one of the purpose, the citation, or intended use of the protected data element into the database of registered protected data elements; and
commit the code element into the codebase.

17. The system of claim 15, wherein the processing device is further caused to:
based on a response received from the developer account, deny insertion an entry for the protected data element into the database of registered protected data elements; and
at least temporarily prevent a commit of the code element into the codebase.

18. The system of claim 12, wherein the processing device is further caused to:
receive, by a machine learning model, a set of training queries and a set of training protected data elements; and
train the machine learning model to generate at least one query based on a data set including at least one protected data element.

19. The system of claim 12, wherein to search a database of registered protected data elements for the protected data element, the processing device is further caused to:
generating a comparison of a metadata of each entry in the database of registered protected data elements with corresponding metadata of the protected data element; and
determine, using the comparison, if at least one entry in the database of registered protected data elements matches the protected data element.

20. The system of claim 19, wherein the query is configured to identify at least one of a sensitive permission declaration, a run-time request for permission to access a protected data element, an access to a variable having a variable name that matches a name of a protected data element, a sensitive data model that stores one or more protected data elements, a reference to a sensitive data model, a declaration of a sensitive data model, a use of a sensitive data model, a class that instantiates a sensitive data model as a local variable or parameter, a sensitive application programming interface (API) that accesses one or more protected data elements, a utility function that transitively invokes a sensitive API, or an invocation of a sensitive API.
